(19) United States
(12) Patent Application Publication
(10) Pub. No.: US 2014/0143068 A1
(43) Pub. Date: May 22, 2014

(54) MEDIA CONTENT CREATION AND PROCESS WORKFLOW

(71) Applicant: Fox Digital Enterprises, Inc., Los Angeles, CA (US)

(72) Inventors: Steven E. Simonian, Los Angeles, CA (US); William Robert Morales, Arcadia, CA (US); Jason C. Colbert, Sherman Oaks, CA (US)

(73) Assignee: FOX DIGITAL ENTERPRISES, INC., Los Angeles, CA (US)

(21) Appl. No.: 14/086,521

(22) Filed: Nov. 21, 2013

Related U.S. Application Data
(60) Provisional application No. 61/729,153, filed on Nov. 21, 2012.

(51) Int. Cl. G06Q 30/02

(52) U.S. Cl. CPC G06Q 30/0276
USPC 705/14.72

(57) ABSTRACT

A method, system, apparatus, and computer-program product provide the ability to create a promo. Media items to be used in a promo are obtained. A low-res proxy version of the media items is created and provided, across a network, to an editing application. A promo is edited based on the proxy version and is represented by an EDL. The EDL is transmitted to an approving user. The EDL is then used to dynamically provide the promo to the user using the low-res proxy version of the media items. Input regarding the promo is received from the approving user. Once approved, the EDL is provided to a non-linear high-fidelity editing bay to create a hi-res version of the promo based on the EDL.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Serial No. 61/729,153, filed on Nov. 21, 2012, by Steven Simonian, William Morales, and Jason Colbert, entitled “Media Content Creation and Processing Workflow,” attorneys' docket number 241.28-US-P1.

### BACKGROUND OF THE INVENTION

1. Field of the Invention

The present invention relates generally to the creation and editing of promotional materials for television programming, and in particular, to a file based processing workflow, proxy workflow, and a workflow engine utilized for creating, approving, and providing promotional media content.

2. Description of the Related Art

Promos (i.e., promotions) and teasers are forms of commercial advertising used in broadcast media, to promote a program airing on a television station/network. The processing and creation of such promos/teasers (referred to collectively herein as promos) is a manual laborious process in the prior art that consumes considerable resources and time. It is desirable to create, review, and provide promos (to be broadcast) in an efficient and inexpensive manner. To better understand the problems of the prior art, a description of prior art promo creation and processing is useful.

Promos for television shows (that are to be broadcast) utilize a variety of media content including footage from the television show, audio, graphics, video, images, etc. Promo groups and/or post production groups (consisting of persons who may create such promos) often work in siloed environments wherein the groups do not and are not able to dynamically communicate and/or provide information to other groups. In this regard, producers/writers of the promos are focused on the creative aspects (e.g., the creation of a script to be used for a promo) while editors are focused on actually creating the promo based on the script and working with and utilizing physical tape throughout the editing process. A disconnect exists between the creative process and editing. There is no consolidated workflow that allows producers/writers as well as editors to visualize the creative process.

Promo creation in the prior art begins with a producer/writer creating a script. To create a script, the producer/writer may view dailies. Dailies are raw unedited footage shot during the making of media content such as a television show or motion picture. Further, there are hundreds of hours of dailies per week for any given television network. The producer/writer views the dailies and generates a log (e.g., a script) that identifies the elements/effects in the dailies that the writer/producer wants to highlight for a promo. Based on the log/script, an editor, who is usually compensated on an hourly basis, utilizes a high definition edit bay (for which there may be limited availability) to stitch together the different elements and create a viewable promo. In addition, the writer/producer may physically go to the edit bay with the editor and view the dailies. Once created, the promo is then dubbed to tape. The tape is physically delivered to the producer/writer for his/her review and approval as well as approval by any other personnel that may be necessary (e.g., a show level producer/writer, a network level producer/writer, etc.). If any edits are to be performed, notes are provided to the editor for another creative approval cycle.

In view of the above, the creative/edit/approval cycle for a promo is time consuming, utilizes considerable resources, and is not environmentally friendly (e.g., multiple cycles of laying promos to tape and physically transporting such tape to the relevant parties). In addition, it may be useful for multiple groups to create different promos based on different concepts such that an executive (e.g., a supervisor/producer) can select the preferred promo for actual use. Such a process adds additional expense and time to the promo creation process.

It is desirable to limit the amount of time spent on an edit bay by editors as well as improving the efficiency and workflow of the promo creative/editing/approval process.

### SUMMARY OF THE INVENTION

Embodiments of the invention provide the ability for a script/storycut to be created and edited at a producer's desktop using a proxy/low-res version of the media items. Once created, an edit decision list (EDL) may be used to stream a low-res version of the promo to a multitude of users for viewing and approval. Once an approval of the promo has been obtained, a hi-res version of the promo can be produced based on the information in the EDL (e.g., by editors that have access to hi-res version of the media items). Accordingly, embodiments of the invention enable the entire promo creation and approval process to be executed on a desktop/web based interface across a relatively low-bandwidth network (and/or Internet) connection. The use of the low-res proxy version of the media items allows a producer to view dailies and other versions of the content in a less robust form (than the hi-res formatted data) before proceeding through the time-consuming and expensive editing process.

In summary, embodiments of the invention provide a digital file-based system wherein promos can be created using proxies to enable producers/writers/creative executives to create, edit, and approve of promos prior to utilizing a hi-fidelity hi-res editing bay and without the need to lay tape at every step in the process.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 illustrates the components of a system/solution to create and approve promos in accordance with one or more embodiments of the invention;

FIG. 4 illustrates a system diagram for the various components used to create and approve promos in accordance with one or more embodiments of the invention;

FIG. 5 illustrates an exemplary naming convention in accordance with one or more embodiments of the invention;

FIG. 6 illustrates a notification task list that contains all of the notifications created by the media engine in accordance with one or more embodiments of the invention; and

FIG. 7 illustrates the logical flow for creating a promo in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention provide a desktop approach/workflow for the promo creation/editing/approval process. Instead of creating a log/script used by editors, producers/writers utilize proxy versions of the media content to actually create a promo on a desktop computer. Information (e.g., an edit decision list) regarding the promo can be utilized to stream the promo (via the Internet or other network) to multiple parties for circulation/approval. Thereafter, the editors utilize the information to create a high definition version of the promo. Thus, the promo creation process is digital and streamlines the creation/approval process.

### Hardware Environment

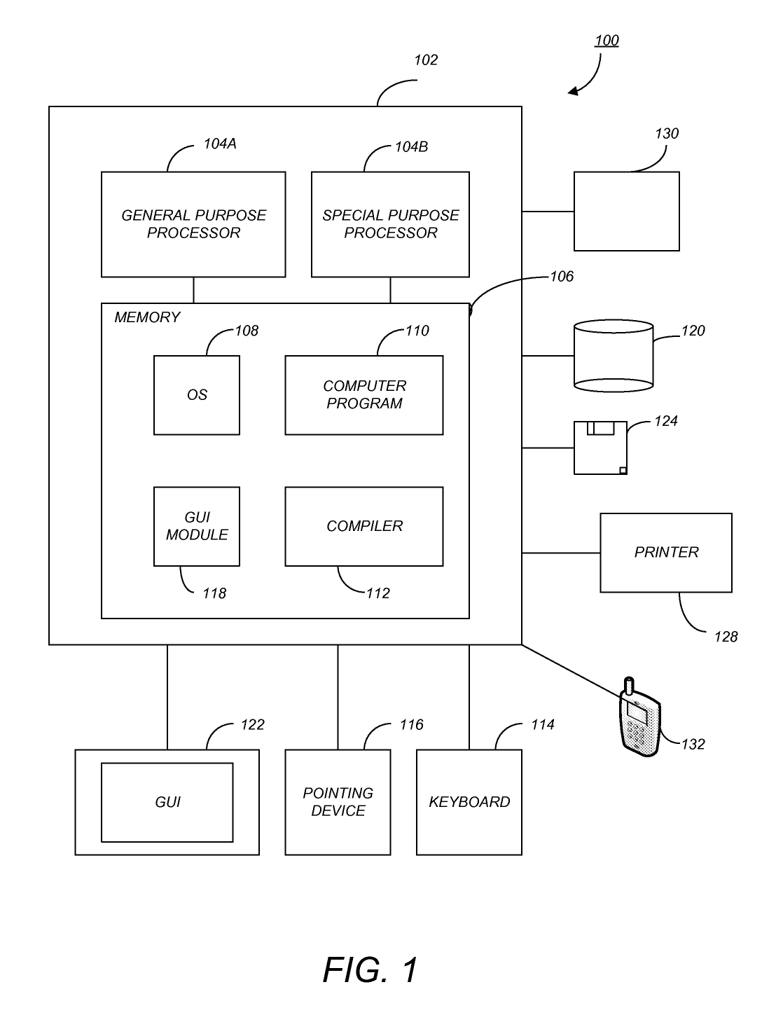

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor 104B is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to implement and/or use the present invention or to load the program of instructions into a memory 106, thus creating a special purpose data structure causing the computer 102 to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

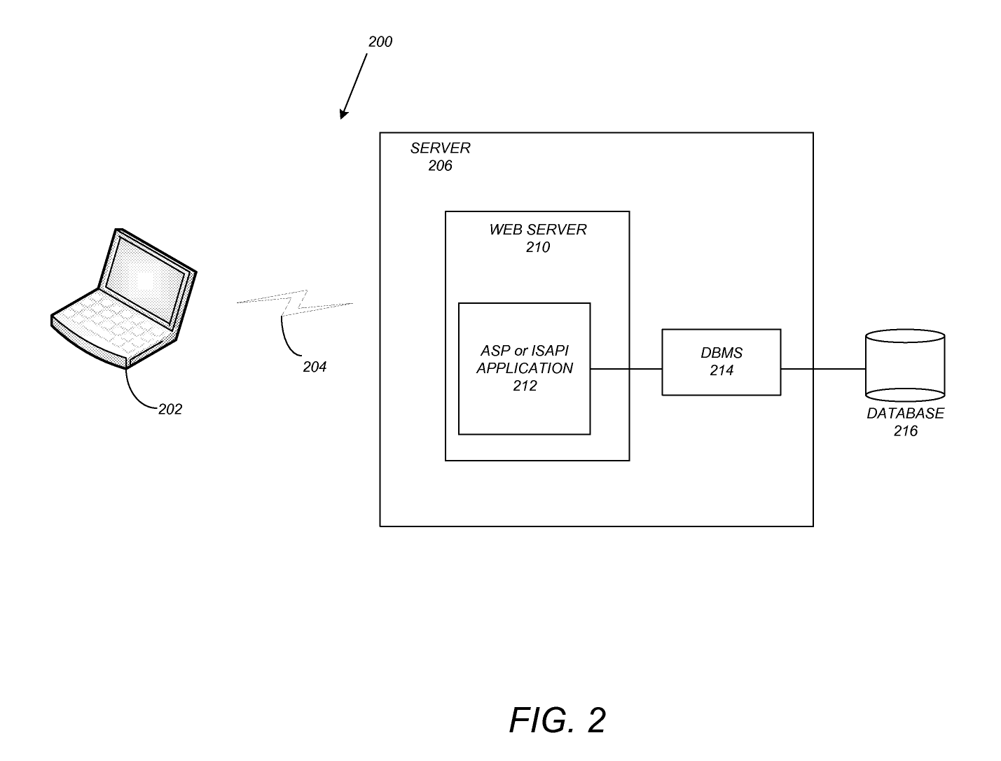

FIG. 2 schematically illustrates a typical distributed computer system 200 using a network 204 to connect client computers 202 to server computers 206. A typical combination of resources may include a network 204 comprising the Internet, LANs (local area networks), WANs (wide area networks), SNA (systems network architecture) networks, or the like, clients 202 that are personal computers or workstations (as set forth in FIG. 1), and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 202 and servers 206 in accordance with embodiments of the invention.

A network 204 such as the Internet connects clients 202 to server computers 206. Network 204 may utilize ethernet, coaxial cable, wireless communications, radio frequency (RF), etc. to connect and provide the communication between clients 202 and servers 206. Clients 202 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, etc. Further, the software executing on clients 202 may be downloaded from server computer 206 to client computers 202 and installed as a plug-in or ACTIVEX™ control of a web browser. Accordingly, clients 202 may utilize ACTIVEX™ components/component object model (COM) or distributed COM (DCOM) components to provide a user interface on a display of client 202. The web server 210 is typically a program such as MICROSOFT′S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 202 instead of communicating/obtaining the information from database 216 across network 204. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT′S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 202 and 206 may be interchangeable and may further include thin client devices with limited or full processing capabilities, portable devices such as cell phones, notebook computers, pocket computers, multi-touch devices, tablet devices (e.g., iPad™) and/or any other devices with suitable processing, communication, and input/output capability.

Of course, those skilled in the art will recognize that any combination of the above components, or any number of different components, peripherals, and other devices, may be used with computers 202 and 206.

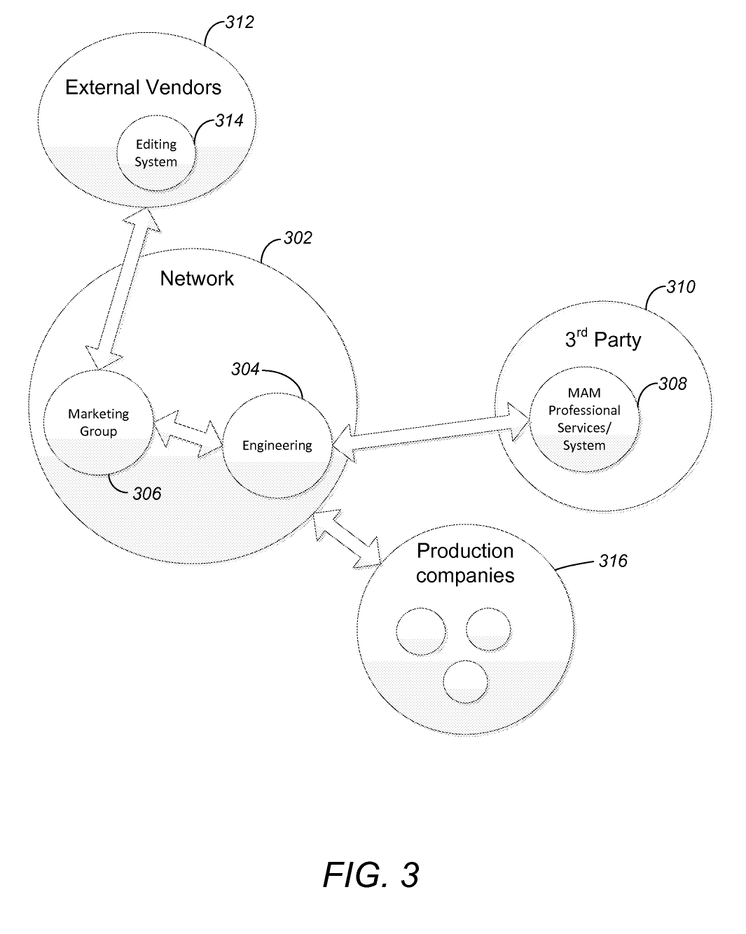

FIG. 3 illustrates the components of a system/solution used to create and approve promos in accordance with one or more embodiments of the invention. Each component may utilize computers 100, 202 and 206 and may communicate with each other across a network in accordance with one or more embodiments of the invention.

A network (e.g., Fox Broadcasting Company™) 302 creates and distributes programming to affiliate stations (e.g., including television outlets that may be owned by the network). Each network 302 may have an engineering group 304 that represents the engineering interest for multiple facilities nationwide and is responsible for all aspects of operations and engineering for these facilities. The marketing group 306 is responsible for the creative marketing strategy for all sows aired on a network 302 and may be responsible for all branding for the network on all forms of media. Engineering 304 may provide specifications and systems (e.g., the media asset management [MAM] system/professional services 308 available from a third party vendor/integrator 310 [e.g., the Vizrt™ company) that are used by the marketing group 306.

External vendors 312 (e.g., Avid™, etc.) may also provide editing systems 314 (e.g., Media Composer™, ISIS™, Interplay™, etc.) used by the marketing groups 306 to create promos. In addition, various production companies 316 may be used to both produce programming and/or promos used by the network 302. In embodiments of the invention, each of the entities 302-316 may utilize the computers and/or network described with respect to FIGS. 1 and 2.

The system solution utilized by a marketing group to produce promos may provide one or more of the following benefits over that of the prior art:

(1) File based workflows: Instead of being stored on tape, all the content will be file-based, which means sharing and transferring it will be easier. Embodiments of the invention generate a proxy version for all assets, which will enable any user to search for it and review it from their desktop, either when at a terminal (e.g., client) of network 302 or at home (e.g., via the Internet).

(2) Proxy workflows: Embodiments of the invention export all ingested content to editing systems 314, in the form of an external vendor's 312 compliant proxy. This will save a lot of space on the editing system 314 and will allow editors to have the whole content of a season available in an editing system 314. Through a 3^{rd} party 310 application 308, editors will be able to request the staging of the hi-res (high resolution) media content for segments of clips they use in their sequences.

(3) Archive Restore: Embodiments of the invention integrate with a storage manager to automatically create a copy of ingested content on a storage library (e.g., a tier-3 archive storage library), allowing the conservation of space on the more expensive disk storage. Anytime content that is stored on such a library is needed, embodiments of the invention may automatically trigger a full or partial restore.

Workflow engine: Embodiments of the invention support the ingest, triage and promo approval workflows described herein. Users will be notified when they have a new task to do, and will use a task list interface to review and approve content.

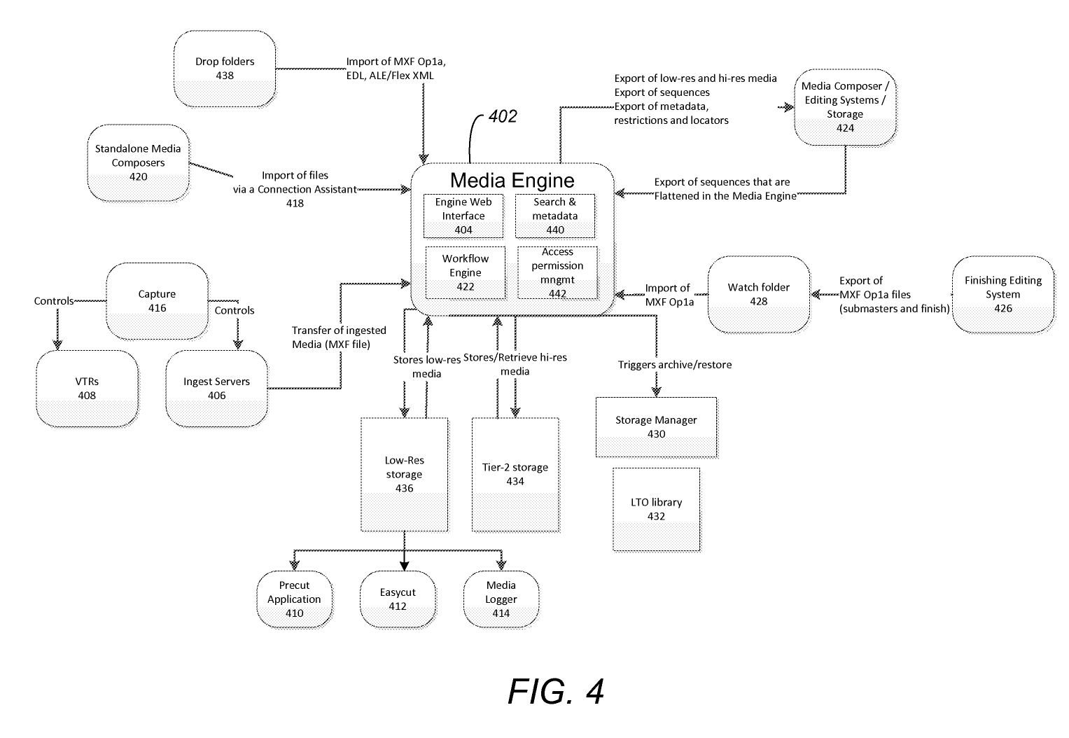

FIG. 4 illustrates a system diagram for the various components used to create and approve promos in accordance with one or more embodiments of the invention. The media engine 402 is the MAM (Media Asset Management) system 308, and more specifically, the backend. The media engine 402 is composed of a set of servers (application servers, web servers, transcoders, etc.). The media engine 402 may use a database management system (e.g., a relational database model system [RDBMS] such as a DB2™ model) to manage and maintain data.

Engine web interface 404 provides a web interface to media engine 402. Through the web interface, 404, users can search media, browse media in a web, access task lists, view and update assets' metadata, update access permissions on the media, and monitor transfer and job's status.

Each ingest server 406 is capable of ingesting two concurrent SDI (serial digital interface) streams and will create files (e.g., MXF Opla DN×HD 720p59.94) that will be imported into the media engine 402. As used herein, MXF refers to Material eXchange Format (MXF) that is a container format for professional digital video and audio media defined by a set of SMPTE (society of motion picture and television engineers) standards. MXF is a container or “wrapper” format that supports a number of different streams of coded items together with a metadata wrapper that describes the material contained within the MXF file. MXF Opla and MXF Op-Atom are different types of MXF files that adhere to particular operational patterns. The ingest servers 406 may require timecodes to be embedded in the input SDI. Each input port of an ingest server 406 may be statically connected to a VTR (video tape recorder) 408.

Precut application 410 is an application (heavy client) that allows browsing the H.264 proxy version of an asset managed in the engine 402 and doing some simple editing. Users can generate a clip list that can be either be conformed into a new asset and stored in media engine 402, or exported as an EDL to an editing system.

Easycut application 412 is an application (heavy client) that allows browsing and simple editing the H.264 (standard for video compression) proxy version of an asset managed in the engine 402. It exposes a bin that can contain several assets, a source window, a composer window, and a timeline onto which clips can be added. Fades and dissolves can be added to a sequence using easycut application 412. A sequence can be either conformed into a new asset and stored in media engine 402, or exported as an EDL to an editing system.

Media logger application 414 is an application (heavy client) that allows browsing the H.264 proxy version of an asset managed in the media engine 402 and logging. Users can mark in and out points in the video and associate metadata with the selected segment. Metadata can be exported to editing systems as subclips, locators, or restrictions.

The capture application 416 is a client application (e.g., executing on the

Windows™ operating system) that is used to ingest content. Capture application 416 controls a VTR 408 via RS-422, as well as video engine ingestion servers 406.

A connection assistant 418 is a plug-in application that runs on editing system workstations (also referred to as an edit bay such as an Avid™ Media Composer™ workstation). The connection assistant 418 is used to export sequences created in workgroup or standalone media composers 424 to the media engine 402. The connection assistant 418 may also be used to export storycuts and roughcuts to the media engine 402. The connection assistant 418 may also be used to stage hi-res media onto the edit system from the media engine 402.

The workflow engine 422 supports customized workflows used in accordance with embodiments of the invention, including ingest, triage, and promo approvals. The workflow engine 422 exposes a set of task lists embedded in the web interface 404 that will show the different tasks, and enable users to update their status, review media, approve promos, etc. The workflow engine 422 may also notify users, both using a notification screen and emails.

In view of the above, editors may use media composers 424 to edit promos. Media composer workstations 424 are connected to additional editing systems (e.g., Interplay™) and storage (e.g., ISIS™). Everything that is ingested in the media engine 402 may be pushed to an editing system in a low resolution format, so that editors have a whole season in an editing system to work. Editors can work using the low-res, and can request a staging of the needed segments of media from the media engine 402 (e.g., using the connection assistant 418). Finished promos can be pushed to the media engine 402 for approval and archiving. Accordingly, the media composer workstation/editing system/storage 424 may receive exported data (e.g., low-res and high-res, sequences, metadata, restrictions, and locators) from media engine 402. Once a promo has been created, the sequences that are flattened are exported back to the media engine 402 (e.g., for approval and archiving).

The media engine 402 may integrate with editing systems via its web service application programming interface 404, and will transfer media to storage (e.g., ISIS™) (e.g., using AMT [Avid™ Media Toolkit™]). Assets may not be automatically synched between the media engine 402 and editing systems (e.g., deleting an asset in the media engine 402 will not delete the asset in an editing system, or vice versa). Additional media composers 420 may be used to ingest OpAtom files in the media engine 402. Such workstations 420 may be “standalone” (i.e., not attached to an editing system such as workstations 424).

Finishing editing systems/workstations 426 (e.g., an editing workstation configured to utilize a Smoke™ editing application) may be used to edit submasters and finish promos. Such an editing system 426 may be referred to herein as a non-linear high fidelity hi-res edit bay. Media engine 402 may not integrate directly with finishing editing systems 426, but may receive its output (as MXF OplA files) in watch folders 428 and import them. As described in further detail below, MXF OplA files stored by the finishing editing systems 426 (i.e., in watch folders 428) may be named according to a convention, so that the media engine 402 can extract some metadata from it, or alternatively, associate them with an existing placeholder.

A storage manager 430 (e.g., Quantum™ storage manager) is used to store information/content for long-term archive. Embodiments of the invention may utilize any HSM (hierarchical storage management) system. The storage manager may utilize magnetic tape storage such as an LTO (linear tape-open) library 432 to store content. The media engine 402 may integrate with the storage manager 430 via an API, to trigger archive and restore operations.

Tier-2 storage 434 (e.g., DataDirect™ Networks [DDN] storage) stores the hi-res media (e.g., MXF files) (e.g., using a Stornext™ file system).

Low-re storage 436 (e.g., Netapp™ storage) stores the H.264 proxies, thumbnails, scripts, etc.

The various components of FIG. 4 described above may be deployed using physical or virtual machines and network connections that span multiple network segments and firewalls/packet inspection gateways.

### Workflow Overview

Based on the above described hardware components of FIG. 4, embodiments of the invention enable and support various workflows for promo creation and approval. The workflows entail ingesting content, managing metadata and media assets, defining access permissions, performing triage, searching media, proxy browsing/editing, logging, working with graphics, importing scripts into the media engine, exchanging promos and media assets with editing systems, utilizing placeholders, approving promos, and archiving and restoring media assets. Each of these processes are described in detail below.

Ingest

Embodiments of the invention allow for the ingestion of:
MXF OplA via drop folders 438;
MXF OpAtom (e.g., via importation into a media composer 420/424, and then exported to the media engine 402 using connection assistants 418). Digital dailies may be imported as a single asset (and MXF file) in the media engine 402, but the start/end and title of each scene may be preserved;
Tapes: using capture application 416.

Metadata and Hierarchy Management

Editing system files (e.g., ALE (Avid™ Log Exchange™) files and Flex™ (an open source application framework for building mobile applications and traditional applications) files that are delivered with the media may be converted to XML (extensible markup language) files, and imported via a drop folder 438. Log entries metadata may be extracted during import, and saved as log track items in the media engine 402 (for later export as subclips in an editing system). In addition, EDL (edit decision list) files that are delivered with media may be imported as-is and associated with the media. As used herein, an EDL is a recording/list of edit decisions. An EDL often complies with a particular format that can be used by multiple different editing systems or media content viewing applications to produce a promo. The EDL can be used to dynamically produce/stream a promo on a portable/thin client device/internet browser, or alternatively, can be used by editors working on a high fidelity edit bay application to produce a final high-res promo.

The media engine 402 allows the management of different types of assets including raw material and promos. Both raw material and promos have different sets of metadata 440 (including search capabilities) associated with them. Assets can be grouped together, using a media engine 402 feature referred to as “folders”, where a show, season, and episodes can be modeled as folders in the media engine 402. The media engine 402 may also provide the ability to navigate the hierarchy (i.e., organizational structure of the metadata/assets in folders), for example, by searching for a show (e.g., “Touch”), then viewing all seasons of the show, selecting one season and viewing all episodes, selecting one episode and viewing all of the associated assets. However, a hierarchical folder representation (e.g., such as that used in an editing system) may not be used by the media engine 402. In this regard, users may be able to search media 440 using the web interface 404. Several search profiles may be available (show, episode, promo, etc.).

Access Permissions

Some material of a network may be secret and access should be restricted.

The media engine 402 may provide for access permission management 442 in which an administrator can define which users can access a folder or an asset. Media managers/administrators may be provided with such capability during a triage workflow in a task list.

Triage

Media managers/coordinators/administrators may be notified each time new media has been ingested and will then be able to perform a triage analysis, using a dedicated task list of the web interface 404. The triage analysis may include checking if the media is ok, updating the asset metadata, setting access permission on the asset to the relevant users, and deciding if the asset should be exported to an editing system 424 (default may be yes), and to what folder the asset should be exported.

Proxy Browsing/Editing

As described above, embodiments of the invention enable a desktop writer/producer to create, browse, and edit a promo. Such promo creation (i.e., outside of the context of a high-res/fidelity edit bay) utilizes proxies. Browsing and editing using a proxy is possible using the precut application 410, easycut application 412, and web interface 404. The browsing and editing capabilities may be utilized to review an asset, create storycuts, and export segments of the media to an editing system (e.g., a hi-res segment). Via the web interface 404 (e.g., using a web player), all audio channels up to six (6) may be played back. Further, remote browsing of the proxy (e.g., outside of a studio's/broadcast network's network) is possible if a client machine has access to required ports of the media engine 402 and if the bandwidth (and latency) is sufficient to browse the proxy.

Logging

Logging may be performed using the media logger 414. In this regard, users may be able to add metadata of several types to segments of media (including restrictions, comments, and markers). Such logged metadata may be exported to an editing system together with the media.

Working with Graphics

Embodiments of the invention may provide the ability to add graphics on a sequence (e.g., for titling/text). To provide such functionality, videos may be generated from graphics files that are then ingested into media engine 402 to create a library of graphics. Users can then search for a graphics video using the web interface 404, and add such content to a timeline using the precut application 410 or easycut application 412 (similar to any other video asset).

Import of Scripts into Media Engine

Embodiments of the invention enable the ability for users to import scripts (e.g., PDF files) into a media engine 402 asset. An upload button may be provided for such a purpose. Scripts associated with an item can be downloaded via the web interface 404.

Exchange with Editing System

Everything that is ingested in the media engine 402 may be pushed to an editing application 424 as a low-res (unless an exception has been defined by a media manager), so that editors have a whole season to work with. Editors can work using the low-res, and can request of staging of the needed hi res segments of media from the media engine 402, using a connection assistant 418. Finished promos can then be pushed to the media engine 402 for approval and archiving. Metadata created in the media logger 414 or extracted from an ALE/Flex XML file may be exported to the editing system 424 as restrictions, markers, and subclips. Promos may be exported from the media composer 424 to the media engine 402, which will trigger an approval workflow.

Placeholder Workflow for Finish Promos

Embodiments of the invention may utilize placeholders for media content/assets. The creation of a placeholder will trigger the generation/update of a report available on a tier-2 storage 434 that will include the list of the promo codes that were created during the day.

As described in further detail below, a placeholder may identify a particular media asset (e.g., a particular frame/clip/etc. in a daily) and as the media evolves (e.g., from a daily to a storycut, to a rough-cut, to a finished cut), the placeholder is updated to reflect the latest version of the content being used in a promo.

Promo Approval

Different types/forms/formats of promos may be created:
Story Cut (e.g., from a precut application 410, editing system or media composer 424, etc.). A story cut is a version of a promo that often consists of the script (created by a writer/producer).
Rough Cut (e.g., from a media composer 424). A rough cut is a version of a promo produced from the story cut and often refers to a working copy of the promo.
Submaster (e.g., produced from a finishing editing system 426 such as Smoke™). A submaster is a version of a promo produced from the rough cut and often refers to a promo version in which tracks are collapsed.
Finish (e.g., produced from a finishing editing system 426 such as Smoke™). A finish is a final or finished version of a promo.

Each of the different promo types/forms/formats follows a specific path for approval:
Story Cut: approved by a managing producer;
Rough Cut: approved by a producer first, then a managing producer, then an executive, and then in parallel by S&P (standards and practices), legal, acquisition, and music rights;
Submaster: not part of the approval workflow; and
Finish: approved in parallel by S&P, Music Clearance, Operations and Acquisition.

The media engine 402 supports such approval paths/workflows by creating a task when a new promo is pushed to the media engine 402, notifying the users who need to approve the promo, presenting the tasks in a task list (that supports filtering and offers direct access to precut application 410 and the media logger 414), and notifying the relevant users when a promo has been approved/rejected.

Archive and Restore

The media engine 402 automatically pushes any ingested media to the file system managed by the storage manager 430 that will write the file on LTO tape 432. Media managers can remove hi-res media from the tier-2 storage 434 (the proxy may always be kept online) via the web interface 404. When the hi-res media is needed (e.g., for conform, export to an editing system 424, export to a network folder, etc.) the media engine 402 automatically triggers a full or partial restore of the needed segments.

### Ingestion

As described above, one part of the promo creation/approval process is that of ingesting/importing media content. More specifically, the ingestion process includes ingesting from tape, importing content from various files (and different file types), triaging the ingested content, and creating shows/episodes. Accordingly, the ingestion/importation of content provides the ability to receive/obtain content in a variety of forms and output the content in a form/format that is usable by media engine 402.

When ingesting content from tape, the tape may be delivered together with an XML file (e.g., that represents an ALE/Flex), or with an EDL in its original format. The XML or the EDL is also imported into the media engine 402. In this regard, during the ingestion process, in/out point may be marked (for the ingestion operation), and metadata may be entered (e.g., via the web interface 404). Once the marked content is ingested (e.g., digital files have been created), any associated XML/EDL file is placed into a drop folder 438 for use (and/or logging) by the media engine 402 (e.g., via the workflow engine 422 of the media engine). Once in the drop folder 438, the workflow engine 422 may update access rights for the content, create a triage task, and notify media managers of the availability of the content.

MXF Opla files and MXF Op Atom files may also be imported (i.e., into the drop folder 438) as part of the ingestion process. When an ALE/Flex XML file or an EDL is available for the file, it will also be placed into the same drop folder 438 as the MXF file. Once imported into the drop folder 438, access rights may be given to a media manager group that is notified of the availability of the content.

Within the drop folder 438, subfolders may be created and used to hold media files. One subfolder may exist for each show (e.g., Glee™). Accordingly, media files put into a show subfolder will be associated with the show.

Once media content has been ingested/imported, media managers/coordinators receive a notification (as described above). Thereafter, the managers/coordinators perform a triage that checks the media (to determine if it is the correct content, if there is any quality control issues, etc.), add more metadata to the media content/asset, specify who can access the media content/asset, and specify if the media content/asset should be exported to an editing system 424 (which may occur by default). Media managers/coordinators may have the option of accepting and/or rejecting the media content/asset based on their evaluation.

The show, season, and episode creation process provides the ability for a media manager, media coordinator, and/or system administrators (or other authorized users) to create new show, season, and episodes in the media engine 402 (which are represented by collections [or folders] in the media engine 402). In this regard, authorized users utilize a user interface to navigate through options (e.g., in the web interface 404) for creating a show, season, or episode folder along with the ability to associate (e.g., create/enter) metadata with the folder. When creating a season, the user may select (e.g., from a list) a show, and the season is automatically placed into a corresponding show subfolder (within drop folder 438). Similarly, when creating an episode, the user selects a season (e.g., from a list), and the episode is automatically placed into a corresponding season folder.

Exchange with Editing System

As described above, authorized users may export a whole media item to an editing system 424 using the web interface 404. A user may choose to export either a hi-res or low-res version of the item, and decide into which workspace and editing system folder (e.g., by specifying a specific folder or sending to a default destination), the item should be exported. An external system may also trigger the export of a whole item to an editing system 424. Such an export may be performed by the workflow engine 422 (i.e., to export media to the editing system 424 after triage has been completed).

In view of the above, the media engine 402 may determine a destination for a promo/media item based on the metadata associated with a file (which may be set forth in the filename of the promo). The media engine 402 may fetch the values of the following metadata fields as part of this process:
Show Name: or the show to which the item belongs;
Season Year Range: of the season to which the item belongs;
Season Number: of the season to which the item belongs;
Episode Number: of the episode to which the item belongs; and
Asset Category: of the item.

If the asset category is “Daily”, then the appropriate folder may be:

### Incoming Media\Sources\<Show Name>\Season <Season Year Range>(<Season Number>)\Dailies <Season Number><Episode Number>

If the asset category is “Shoot”, then the appropriate folder may be:

### Incoming Media\Sources\<Show Name>\Season <Season Year Range>(<Season Number>)\Shoot

If the asset category is neither “shoot” nor “daily”, then the appropriate folder may be:

### Incoming Media\Sources\<Show Name>\Season <Season Year Range>(<Season Number>)\Shoot

The export operation results in a master clip being created in an editing system 424 folder defined by the selected destination. In addition, metadata associated with the item may be exported to the editing system 424. Such metadata may include:
Item metadata: exported as master clip metadata;
Restrictions: exported as restrictions associated with the master clip;
ALE/Flex log entries: exported as subclips;
Annotation: exported as locators associated with the master clip; and
Markers: exported as locators associated with the master clip.

A static mapping may be used to define which item metadata fields are exported to editing system 424, and to what metadata fields they are mapped. Based on an item's metadata, the media engine 420 can automatically determine a target workspace and editing system 424 folder.

If a version of the item (e.g., hi-res or low-res) has already been exported to an editing system 424 and has not been deleted, a transfer of the media is not conducted (e.g., as long as the version requested is the same or lower resolution that that already exported). However, a new master clip may be created (duplicate), as well as restrictions, locators, and subclips. Further, when exporting a hi-res for a whole item, the media engine 402 may check if the proxy for the whole item is already available in the editing system 424, and if so, the same source identification when creating the master clip may be used (in order to allow dynamic relinking)

In addition to the above, an authorized user may create a sequence/EDL/shotlist in the precut application 410 or easycut application 412 and export such a sequence/EDL/shotlist to an editing system 424.

Hi-Res Staging in Media Composer

Once a promo has been created using proxies (i.e., low-res version of the media assets/items/content) and approved, a hi-res version may need to be produced. In this regard, editors who work with the low-res version in a media composer 424 may be able to request the hi-res version from the media engine 402. An editor can drag a sequence or a clip from a media composer bin onto a “stage hi-res” drop area of a connection assistant 418 to initiate the staging of the sequence or clip hi-res. A master clip, or a segment of a sequence qualifies for “stage hi-res” if the format of the master clip is the proxy format, the master clip as been created by transferring an item or a sequence from the media engine 402 to the editing system 424 (or is a duplicate from such a master clip), and the media engine 402 has not already sent the hi-res version for the master clip/segment to the same workspace.

When a stage hi-res request is initiated for a qualifying master clip, a new master clip is created in the editing system 424 for the hi-res and the media engine 402 transfers the hi-res media to the editing system 424 and associates it with the hi-res master clip. The creation of the new master clip provides that the new master clip has the same source ID as the proxy master clip, the hi-res master clip has the same name as the proxy master clip (with a “.hi-res” suffix), and the hi-res master clip is created in the same editing system 424 folder as the proxy master clip.

When a stage hi-res is requested on a sequence, for each segment of the sequence that qualifies, a new mater clip is created in the editing system 424 for the hi-res, and the media engine 402 transfers the hi-res media to the editing system 424, for the segment references in the sequence only, and associates it with the hi-res master clip. When creating the new master clip, the hi-res master clip has the same source ID as the proxy master clip, the hi-res master clip has the same name as the proxy master clip (with a “<tc_in>.hi-res” suffix, where <tc_in> is in the timecode of the subclip in format hhmmssff [see further details below]).

The transfer of hi-res media files to an editing system 424 may commence as soon as a user has dropped a sequence/clip on a connection assistant 418 “stage hi-res” area. In this regard, the user may not be required to confirm or enter additional information.

Import from Media Composer into Media Engine

Once a promo has been created in a media composer 424, the promo may be imported into the media engine 402. In this regard, the media composer 424 may produce an AAF (advanced authoring format) sequence that needs to end up as a single MXF Opla file in the media engine 402. A user can initiate the import process in a graphical user interface by dragging a sequence onto a connection assistant 418. In response, the user may be prompted (e.g., within a connection assistant 418) to select the relevant form to input metadata, for each specific use case (e.g., story cut, rough cut, etc.). Thereafter, the transfer will commence with the status displayed to the user (e.g., in connection assistant 418 and the web interface 404).

### Promo Approval Workflow

As described above, the various forms/formats of the promos proceed through an approval workflow. Each of the different promo types/forms/formats follows a specific path for approval. As used herein, the approval process includes the import of a promo from a media composer 424 into the media engine 402, the import of a promo created with a precut application 410 into the media engine 402, the import of a promo from a finishing editing system 426 into the media engine 402, promo check-in, and promo approval.

Import of Promos from Media Composer into Media Engine

Users (producers, editors) will create promos (story cut, rough cut) in a media composer and/or editing system 424. Those promos will be exported to the media engine 402 using a connection assistant 418 (in order to proceed through the approval workflow). Once a promo has been imported, it will be referenced in a task list, ready to be checked-in by the producer.

A user may create a promo (e.g., a producer may create a story cut and/or an editor may create a rough cut) using the media composer/editing system 424. In this regard, the user can select the type of promo to be exported to the media engine 402 (i.e., story cut or rough cut). Such a selection may be conducted in a variety of manners including via a graphical user interface such as a drop down list in a connection assistant 418. In the metadata form, the producer may have to enter various metadata fields including show name, producer, promo name, duration, episode season, etc. Such a combination of metadata files defines a specific promo. If another promo with the same combinations of value is submitted, it will be a new version of the same promo.

Import of Promos Created in Precut Application into Media Engine

The importation of promos created in the precut application 410 into the media engine 402 is similar to the process of importing promos from the media composer 424 into the media engine 402 but for where the promo is created.

Import of Promos from Finishing Editing System into Media Engine

Users (e.g., finishing editing system editors) will create some types of promos (e.g., submasters, finish) in a finishing editing system 426. Those promos will be exported to the media engine 402 as MXF Opla files via a drop/watch folder 428. Thus, the dropping of the promo into a watch folder 428 (one watch folder may exist for submasters and another folder for finishes) triggers the importation of the promo into the media engine 402. Metadata of the newly created asset may be pre-filled based on the name of the file (see description below for the naming convention) with additional metadata added via a web interface 404. After the promo has been imported, it will be referenced in a task list (e.g., by the finishing editor), ready to be checked-in by a producer (see description below).

Promo Check-In

After a promo has been pushed to the media engine 402 (from precut application 410, finishing editing system 426, or media composer 424), the producer needs to define who should review and approve the promo, as well as who should be notified when a promo has been approved/rejected. The producer defines such information by “checking-in” the promo. The producer receives a notification when a promo (e.g., a story cut, rough cut, or finish) needs to be checked-in (i.e., when a promo has been added to a task list). Submasters may not need to go through the check-in process, as they do not go through an approval process in the media engine 402. Different task lists may be used to check-in the promo depending on the type of promo (i.e., a story cut task list, rough cut task list, and finish task list).

To check-in a promo, the producer proceeds to the relevant promo task list, selects the desired task, selects/clicks “check-in”, defines who should approve the promo, and selects/clicks “submit.” Thus, the story cut, rough cut, and finish task lists expose a “check-in” button that, when clicked displays a “check-in” form. The “check-in” form contains a drop down for each department that needs to approve a promo or be notified when the promo is approved/rejected. This varies depending on the type of promo. For example, story cut needs to be approved by a managing producer, and an editor needs to be notified when it has been approved.

Promo Approval

After a promo has been checked-in by a producer, the promo needs to be approved by the relevant persons (selected by the producer during the check-in step). Depending on the type of promo, the number of persons doing approval, as well as the order may vary. To approve a promo, a proxy version of the promo may be viewed (e.g., on a user's desktop/thin client device/etc.) with the ability for the user to set the approval status and enter comments, if desired.

For rough cuts and finish, the producer may perform a first approval step and either approve or reject the promo. If the promo is approved by the producer, the designated persons from acquisition, managing producer, music, S&P, legal, and executive are notified (and the task state may change to partially approved). The designated persons (i.e., from acquisition, managing producer, music, S&P, legal, and executive) will, in parallel, review and approve/reject the promo. If the promo is rejected by the producer, the producer is notified and the task state is changed to “rejected”. Once all designated parties have approved the promo, all of the designated persons are notified and the task state changes to “approved”. If the promo is rejected by at least one person (i.e., from acquisition, managing producer, music, S&P, legal, and executive), all of the parties are notified and the task state is changed to “rejected”.

For story cuts, there is a single approval step, performed by the managing producer, who will either approve or reject the promo. If it is approved by the managing producer, producers and editor are notified and the task state changes to “approved”. If it is rejected by the managing producer, the producer is notified and the task state is changed to “rejected”.

In addition to the above, a symbol (e.g., a green tick, red cross, etc.) may be displayed in the task list, for each approval stats by the different departments.

After a user has edited a task, any comments entered by the user are saved in a field associated with the promo item. Once a promo has been fully approved or rejected, its approval status metadata filed is updated. After 72 hours, approved and rejected tasks are set to state “complete-approved” or “complete-rejected” and will not appear in a “normal” view of the task list, but will appear in a “history” view instead.

File Naming Convention

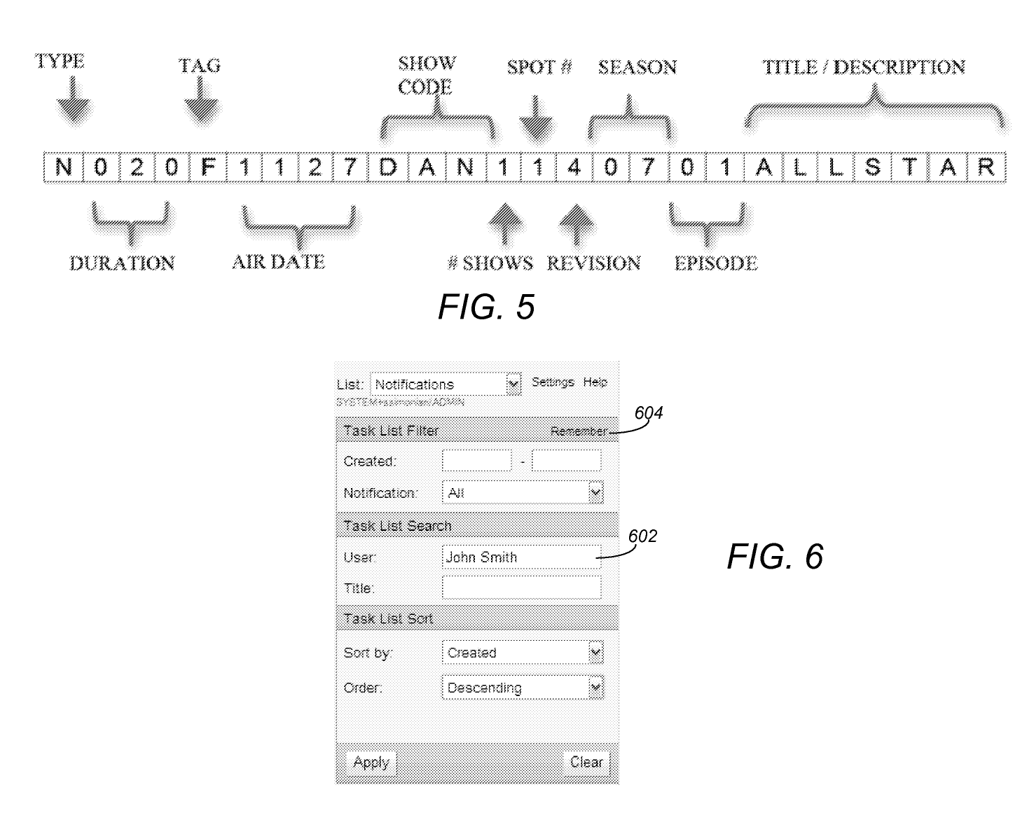

Promos may be created by editing system 424 and/or finishing editing system 426. To ensure that the files are tracked, organized, and maintained properly, the file representing the promo should comply with a file naming convention. Embodiments of the invention are not limited to any one naming convention. FIG. 5 illustrates an exemplary naming convention in accordance with one or more embodiments of the invention. Table A below provides a description of the various fields illustrated in FIG. 5.

TABLE A

| FIELD | COLUMN | DESCRIPTION |
|---|---|---|
| TYPE | 1 | Type of promo (N = Network, S = |
| | | Station, etc.) |
| LENGTH | 2-4 | Length of promo in XYY (X = Minutes, |
| | | YY = Seconds) |
| TAG | 5 | Tag type (A = Day of week, Y = |
| | | Tomorrow, B = Tonight, etc.) |
| AIR DATE | 6-9 | Date episode airs in MMDD (MM = |
| | | Month, DD = Day) or GNYY for |
| | | Generic |
| SHOW CODE | 10-12 | Three letter show name abbreviation |
| | | (GLE, HOU, DAN, 99X, etc.) |
| # SHOWS | 13 | Number of shows included in this promo |
| | | (1-9) |
| SPOT # | 14 | Number of spots (or reissue) of the promo |
| | | (1-9) |
| REVISION | 15 | Number of revisions of the promo (1-9) |
| SEASON | 16-17 | Season number (01-99) or GN for Generic |
| EPISODE | 18-19 | Episode number (01-99) or YY for Year |
| TITLE/ | 20-32 | Descriptive name or title of the promo |
| DESCRIPTION | | (variable length) |

### Notifications

As described above, embodiments of the invention may utilize a graphical user interface that provides the ability for users to both create, edit and/or approve of promos. During the approval process, different task lists may be used to check-in the promo depending on the type of promo (i.e., a story cut task list, rough cut task list, and finish task list). FIG. 6 illustrates a notification task list that contains all of the notifications created by the media engine 402. By default, the task list contains all notifications for all users. A user can specify a permanent filter so that it will only show a particular user's tasks in the future. To establish a permanent filter, the user enters his/her name in the user field 602 and clicks the “remember” label 604.

Once a user has seen a notification, the user can click the “confirm” button to remove the notification from the list. Notifications that are not confirmed may be compiled on a defined periodic basis (e.g., twice a day) and sent to a user as an email (that may/may not include removing the task from the task list).

### Logical Flow

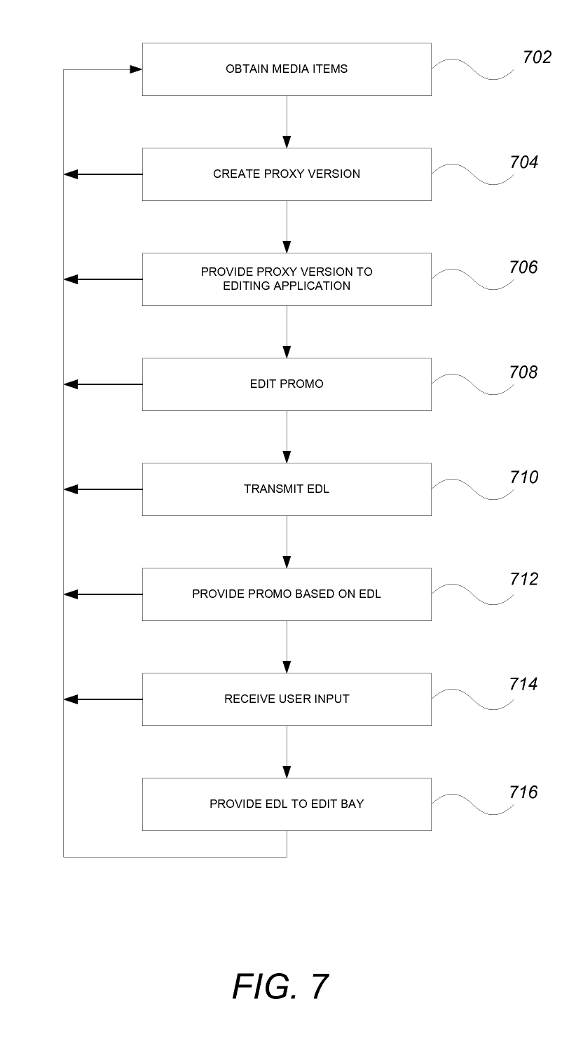

FIG. 7 illustrates the logical flow for creating a promo in accordance with one or more embodiments of the invention.

At step 702, media items to be used in a promo are obtained. The obtained media items may be accompanied by an XML file that represents edit decisions performed on the media by an editing system (e.g., an EDL, ALE/Flex file). Further, the media items may be obtained by ingesting the media items from tape, importing items from a drop folder, and/or importing the media items from a media composer via a connection assistant. Step 702 may also include conducting a triage operation that checks the obtained media items (e.g., for errors), adds metadata to the media items, specifies who can access the media items, and specifies if the media items should be exported to an editing system.

At step 704, a low-res proxy version of the media items are created. Such proxy versions may consist of files.

At step 706, the low-res proxy version of the media items are provided, across a network, to an editing application.

At step 708, the editing application is used to edit a promo based on the low-res proxy version of the media items. The editing step 708 includes both modifying/editing an existing promo as well as creating a new promo. The resulting promo is represented by an edit decision list (EDL) that is a listing of edit decision performed on the media items (e.g., the low-res version of the media items) to create the promo.

In embodiments of the invention, placeholders are used to represent the media items. These placeholders represent a metadata only asset in the system that at a later time can be associated with the media asset. Such placeholders are identified in accordance with a metadata schema or file naming convention that identifies the media items. The placeholders are configured to accept new versions of the media items based on the file naming convention. The edit version of the promo (EDL) references the placeholders. Further, the promo resulting from the EDL utilizes the new versions of the media items based on the placeholders. Accordingly, as new versions of the media items are produced (e.g., from creative cut to story cut to rough cut and finish), the placeholders enable the newer versions of the media to be associated in the promo throughout the workflow cycle.

At step 710, the edited media (EDL) is transmitted to an approving user. Such an approving user may be a producer, a managing producer, S&P, legal, acquisition, music, and/or executives.

At step 712, the promo is dynamically provided to the approving user using the low-res proxy version of the media items based on the EDL. Such a promo may be streamed to the user and/or transmitted as a file to the user. In one or more embodiments, the approving user views the promo that is provided on a thin client device and/or any device that has a web interface.

At step 714, input is received from the approving user. Such input may be an approval of the promo, a rejection of the approval, and/or comments/markups/further edits suggested/required by the approving user.

At step 716, the EDL is provided to a non-linear high fidelity editing bay to create a hi-res version of the promo based on the EDL.

As noted in FIG. 7, the steps 702 are dynamic in that each of the steps may be performed repeatedly at any stage in the process. In this regard, the editing-approval cycle may be performed numerous times before being forwarded to the high-fidelity edit bay to produce the hi-res version of the promo. Similarly, after a promo has aired/been broadcast, further edits may be requested by a producer thereby causing the editing/approval cycle to continue.

### Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for creating a promo comprising:
obtaining media items to be used in a promo;
creating a low-res proxy version of the media items;
providing, across a network, the low-res proxy version of the media items to an editing application;
editing, using the editing application, a promo based on the low-res proxy version of the media items, wherein the promo is represented by an edit decision list (EDL) comprising a listing of edit decisions performed on the media items to create the promo;
transmitting the EDL to an approving user;
dynamically providing the promo to the approving user using the low-res proxy version of the media items based on the EDL;
receiving input from the approving user; and
providing the EDL to a non-linear high-fidelity editing bay to create a hi-res version of the promo based on the EDL.

2. The computer-implemented method of claim 1, wherein:
the obtained media items are accompanied by an extensible markup language (XML) file that represents edit decisions performed on the media items by an editing system.

3. The computer-implemented method of claim 1, wherein:
the media items are obtained by ingesting the media items from tape.

4. The computer-implemented method of claim 1, wherein:
the media items are obtained by importing the media items from a drop folder.

5. The computer-implemented method of claim 1, wherein:
the media items are obtained by importing the media items from a media composer via a connection assistant.

6. The computer-implemented method of claim 1, further comprising conducting a triage operation that:
checks the obtained media items;
adds metadata to the media items;
specifies who can access the media items; and
specifies if the media items should be exported to an editing system.

7. The computer-implemented method of claim 1, wherein:
the approving user views the promo on a thin client device via a web interface.

8. The computer-implemented method of claim 1, wherein:
one or more placeholders are used to represent the media items;
the one or more placeholders are identified in accordance with a file naming convention that identifies the media items;
the one or more placeholders are configured to accept new versions of the media items based on the file naming convention;
the edit decisions in the EDL reference the one or more placeholders; and
the promo resulting from the EDL utilizes the new versions of the media items based on the one or more placeholders.

9. The computer-implemented method of claim 1, wherein:
the editing the promo, transmitting the EDL, dynamically providing the promo to the approving user; and receiving approval steps are repeatedly performed dynamically in response to input from the approving user.

10. A system for creating a promo in a computer system comprising:
(a) a computer having a memory; and
(b) a media engine executing on the computer, wherein the media engine is configured to:
(1) obtain media items to be used in a promo;
(2) create a low-res proxy version of the media items;
(3) provide, across a network, the low-res proxy version of the media items to an editing application;
(4) edit, using the editing application, a promo based on the low-res proxy version of the media items, wherein the promo is represented by an edit decision list (EDL) comprising a listing of edit decisions performed on the media items to create the promo;
(5) transmit the EDL to an approving user;
(6) dynamically provide the promo to the approving user using the low-res proxy version of the media items based on the EDL;
(7) receive input from the approving user; and
(8) provide the EDL to a non-linear high-fidelity editing bay to create a hi-res version of the promo based on the EDL.

11. The system of claim 10, wherein:
the obtained media items are accompanied by an extensible markup language (XML) file that represents edit decisions performed on the media items by an editing system.

12. The system of claim 10, wherein:
the media items are obtained by ingesting the media items from tape.

13. The system of claim 10, wherein:
the media items are obtained by importing the media items from a drop folder.

14. The system of claim 10, wherein:
the media items are obtained by importing the media items from a media composer via a connection assistant.

15. The system of claim 10, further comprising conducting a triage operation that:
checks the obtained media items;
adds metadata to the media items;
specifies who can access the media items; and
specifies if the media items should be exported to an editing system.

16. The system of claim 10, wherein:
the approving user views the promo on a thin client device via a web interface.

17. The system of claim 10, wherein:
one or more placeholders are used to represent the media items;
the one or more placeholders are identified in accordance with a file naming convention that identifies the media items;
the one or more placeholders are configured to accept new versions of the media items based on the file naming convention;
the edit decisions in the EDL reference the one or more placeholders; and
the promo resulting from the EDL utilizes the new versions of the media items based on the one or more placeholders.

18. The system of claim 10, wherein:
the editing the promo, transmitting the EDL, dynamically providing the promo to the approving user; and receiving approval are repeatedly performed dynamically in response to input from the approving user.
